(19) United States
(12) Patent Application Publication
(10) Pub. No.: US 2012/0026618 A1
(43) Pub. Date: Feb. 2, 2012

(54) Daytime and nighttime light filtering device for the front seat of an automobile

(76) Inventor: Chin-Fu Chuang, Tainan City (TW)

(21) Appl. No.: 12/804,781

(22) Filed: Jul. 30, 2010

(51) Int. Cl. G02B 5/22

(52) U.S. Cl. 359/889

(57) ABSTRACT

A daytime and nighttime light filtering device for the front seat of an automobile includes an outer frame, two winding mechanisms, a daytime strong light-preventing soft screen, a nighttime strong light-preventing soft screen and a positioning mechanism. By mutual action and cooperation of the position mechanism and the winding mechanism, the daytime strong light-preventing soft screen or the nighttime strong light-preventing soft screen can be wound in the winding mechanism or pulled down and unwound for use if necessary, able to effectively filter strong light and taking little space.

### BACKGROUND OF THE INVENTION

1. Field of the Invention

This invention relates to a daytime and nighttime light filtering device for the front seat of an automobile, particularly to one able to be conveniently and quickly positioned on the windshield of an automobile for preventing strong light, having effects of obstructing sunlight and protecting eyes.

2. Description of the Prior Art

Generally, one of the troubles a driver encounters is that the sun projects strong light upon the eyes directly and makes a driver unable to open his eyes, rendering a driver impossible to drive with safety. To solve such a problem, a driver usually has to wear sunglasses for blocking off the strong sunlight. However, when a driver forgets to bring sunglasses with him, or if driver is near sighted or farsighted and already has such eyeglasses on but has to additionally wear dark glasses, it will surely cause much trouble to the driver. Although each automobile is provided with visors over the front seat for blocking off the sunlight, yet the visor that is opaque may also obstruct a driver's eyesight. In another case, if the driver is short-statured, and when the sun just rises or is to set and horizontally projects light to the interior of an automobile, the visor above the front seat will become useless and the driver has to wear sunglasses in order to block off the sunlight, thus resulting in much trouble to a driver.

To solve foresaid problems caused by the opaque visor that may block off a driver's eyesight, a sunlight-obstructing device for an automobile has been researched and developed, as disclosed in U.S. Pat. No. 3,183,033, No. 6,328,371, No. 4,171,845, No. 3,584,910, No. 5,076,633 and No. 6,318,789, and No. 11/351,960 filed by the applicant of this invention.

### SUMMARY OF THE INVENTION

The objective of this invention is to offer a daytime and nighttime light filtering device for the front seat of an automobile, convenient in operation and practical in use.

The characteristics of the inventions are an outer frame, two winding mechanisms, a daytime strong light-preventing soft screen, a nighttime strong light-preventing soft screen and a position mechanism. The daytime and the nighttime strong light-preventing soft screen can be wound in or pulled down from the winding mechanisms so that strong light may be filtered during daytime or nighttime to enable the driver of an automobile to drive safely without using sunglasses.

### BRIEF DESCRIPTION OF DRAWINGS

This invention will be better understood by referring to the accompanying drawings, wherein:

FIG. 1 is a perspective view of a daytime and nighttime light filtering device for the front seat of an automobile in the present invention;

FIG. 2 is an exploded perspective view of the light filtering device for the front seat of an automobile in the present invention;

FIG. 3 is a schematic view illustrating a strong light-preventing soft screen pulled down and unwound for use in the present invention;

FIG. 4 is a schematic view illustrating the strong light-preventing soft screen being wound up by the ratchets in the present invention;

FIG. 5 is another schematic view illustrating the strong light-preventing soft screen being wound up by the ratchets in the present invention;

FIG. 6 is a schematic view illustrating a nighttime strong light-preventing soft screen used in the present invention; and

FIG. 7 is a schematic view illustrating that a daytime strong light-preventing soft screen is used in the present invention.

### DETAILED DESCRIPTION OF THE PREFERRED EMBODIMENT

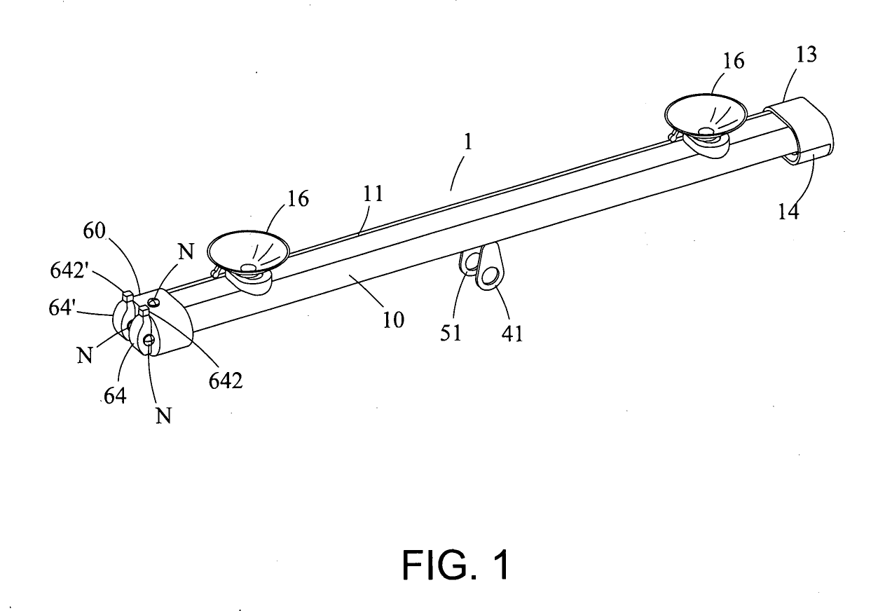

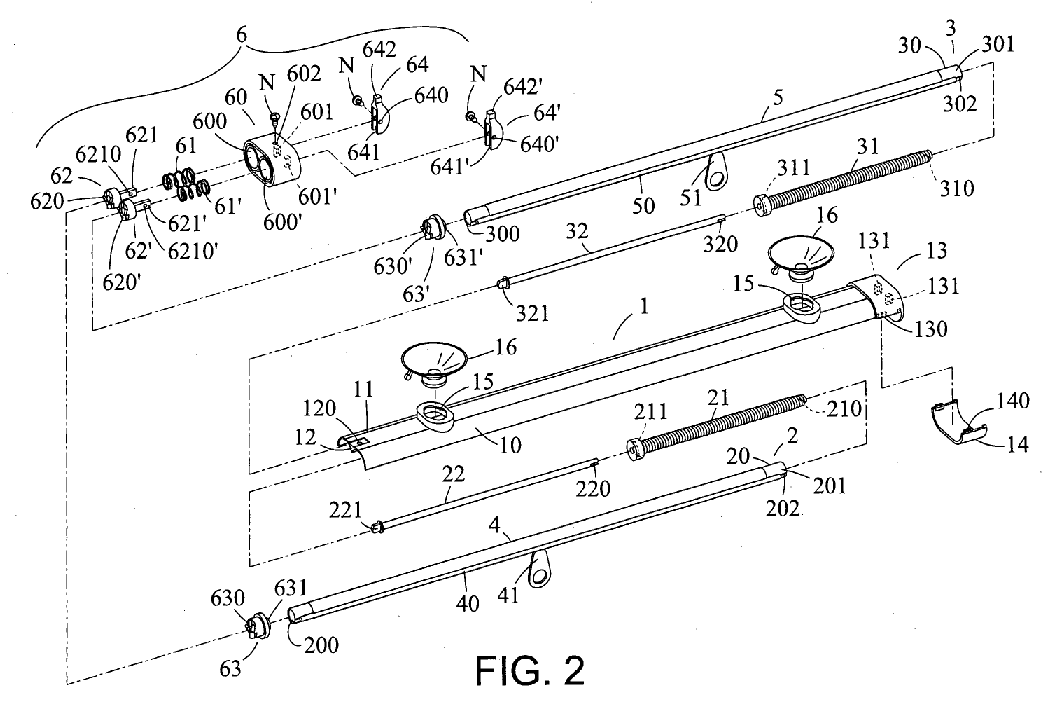

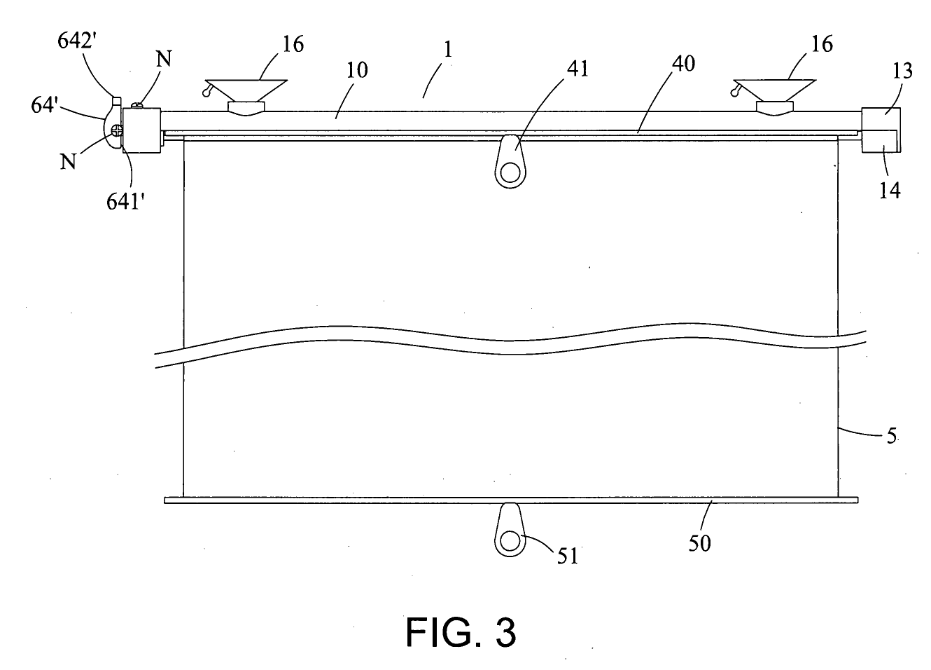

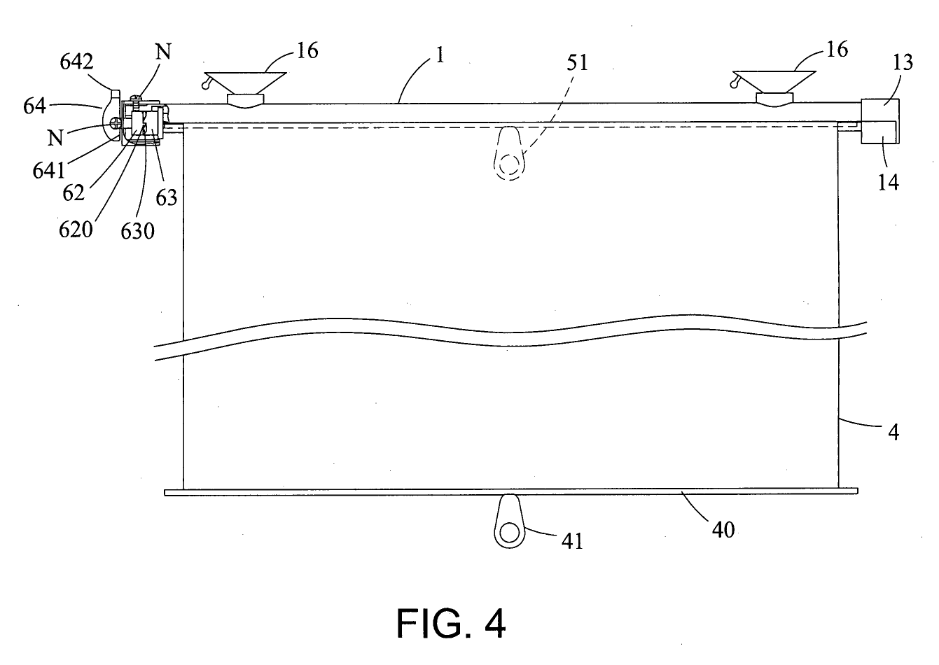

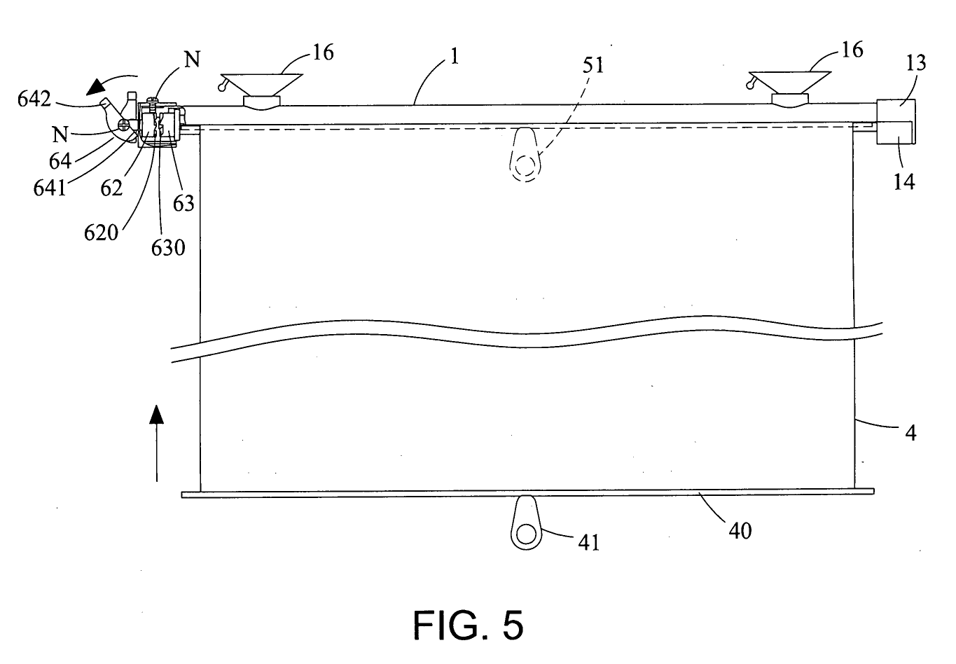

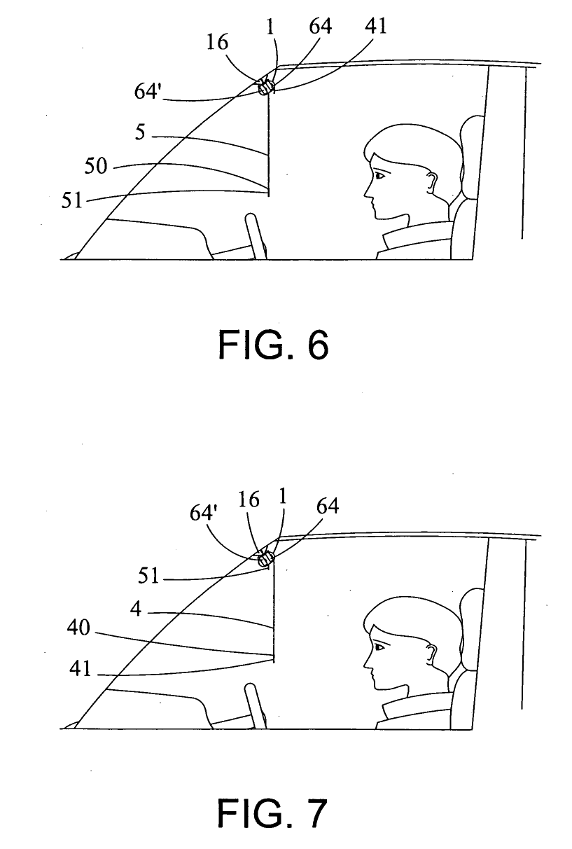

A preferred embodiment of a daytime and nighttime light filtering device for the front seat of an automobile in the present invention, as shown in FIGS. 1 to 7, includes an outer frame 1, two winding mechanisms 2, 3, a nighttime strong light-preventing soft screen 4, a daytime strong light-preventing soft screen 5 and a positioning mechanism 6 as main components combined together.

The outer frame 1 is formed with two circular arc surfaces 10, 11, and has one side provided with an insert groove 12 and a positioning threaded hole 120 and another side mounted thereon with a combining seat 13 and a cap 14. The combining seat 13 is disposed with engage slots 130 and positioning slots 131, while the cap 14 is disposed with insert projections 140 to be respectively engaged with the engage slots 130 of the combining seat 13. The outer frame 1 further has its back side provided with positioning grooves 15 and sucking disks 16.

The two winding mechanisms 2, 3 are respectively fitted in the two circular arc surfaces 10, 11 of the outer frame 1, respectively consisting of a winding tube 20, 30, an elastic member 21, 31, and a braking rod 22, 32. The winding tube 20, 30 is formed with a fitting member 200, 300 at one end and an insert member 201, 301 at another end, and further cut with a notch 202, 302. The elastic member 21, 31 respectively received in the interior of the winding tube 20, is provided with an engage member 210, 310 and an insert groove 211, 311. The braking rod 22, 32 to be inserted in the interior of the elastic member 21, 31 has one end formed with an insert recess 220, 320 and another end fixed with a positioning projection 221, 321.

The daytime strong light-preventing soft screen 4 wound on a first winding tube 20 has one end engaged and positioned in the notch 202 of the first winding tube 20 and then wound around the surface of the first winding tube 20. Further, the daytime strong light-preventing soft screen 4 has its outer end provided with a gravitational member 40 and a pull member 41. Preferably, the daytime strong light-preventing soft screen 4 is made of dark brown-colored filtering material.

The nighttime strong light-preventing soft screen 5 wound around a second winding tube 30 has one end engaged and positioned in the notch 302 of the second winding tube 30 and then wound around the surface of the second winding tube 30, further having its outer end fixed with a gravitational member 50 and a pull member 51. The nighttime strong light-preventing soft screen 5 is made of yellow-colored filtering material.

The positioning mechanism 6 to be fitted on the insert groove 12 of the outer frame 1 is composed of a fitting base 60, elastic members 61, 61′, braking ratchet wheels 62, 62′, engage ratchet wheels 63, 63′ and actuating rods 64, 64′. The fitting base 60 is bored with two fitting round holes 600, 600′, two insert holes 601, 601′ and a positioning threaded hole 602, with the elastic members 61, 61′ respectively received in the two fitting round holes 600, 600′. The two braking ratchet wheels 62, 62′ are respectively fitted in the interior of the two fitting round holes 600, 600′ of the fitting base 60 and extended out the insert holes 601, 601′, respectively having one end provided with a braking engage surface 620, 620′ and another end extended out to form a connecting rod 621, 621′ with an insert hole 6210, 6210′ at the end. The engage ratchet wheels 63, 63′ are respectively fitted on the fitting member 200, 300 of the winding tube 26, 30, respectively having one end formed with a braking engage surface 630, 630′ and another end disposed with an engage portion 631, 631′. The actuating rods 64, 64′ are respectively positioned in front of the insert holes 601, 601′ of the fitting base 60 and provided with positioning, holes 640, 640′, resisting surfaces 641, 641′, actuating members 642, 642′ and screw members (N).

In assembling, firstly, the elastic members 21, 31 of the winding mechanisms 2, 3 are respectively put in the insert recess 220, 320 of the braking rods 22, 32, letting the insert recess 220, 320 of the braking rods 22, 32 fitted with the engage members 210, 310 of the elastic members 21, 31. Next, the elastic members 21, 31 together with the braking rods 22, 32 is inserted in the winding, tubes 20, 30 to let the insert members 201, 301 of the winding tubes 20, 30 engaged and positioned with the insert grooves 211, 311 of the elastic members 21, 31 and to have the positioning projections 221, 321 of the braking rods 22, 32 inserted in the engage slots 130 of the combining seat 13 of the outer frame 1 and firmly engaged together. Subsequently, the fitting member 200, 300 of the winding tubes 20, 30 is fitted with the engage portions 631, 631′ of the engage ratchet wheels 63, 63′ and fixed in place and then, the elastic members 61, 61′ are respectively placed in the fitting round holes 600, 600′ of the fitting base 60 of the positioning mechanism 6, and the connecting rods 621, 621′ of the braking ratchet wheels 62, 62′ are respectively inserted in the interior of the elastic members 61, 61′ and extended out of the insert holes 601, 601 of the fitting base 60. Afterward, the actuating rods 64, 64′ are respectively fixed in place with the braking ratchet wheels 62, 62′ by screw members (N) that are respectively inserted through the positioning holes 640, 640′ of the actuating rods 64, 64′ and also the insert holes 6210, 6210′ of the connecting rods 621, 621′ of the braking ratchet wheels 62, 62′. Then, the positioning mechanism 6 is inserted in the outer frame 1 through the insert groove 12 of the outer frame 1, letting the braking engage surfaces 620, 620′ of the braking ratchet wheels 62, 62′ respectively and mutually engaged with the braking engage surfaces 630, 630′ of the engage ratchet wheels 63, 63′, and a screw member (N) is inserted through the positioning threaded hole 602 of the fitting base 60 and screwed with the positioning threaded hole 120 of the outer frame 1. Lastly, the cap 14 of the outer frame 1 is covered on the combining seat 13 and the sucking disks 16 are respectively fixed in the positioning grooves 15.

In using, after the sucking disks 16 of the outer frame 1 are firmly positioned on the windshield of an automobile, when driving an automobile, a driver can optionally use a suitable strong light-preventing soft screen in accordance with the weather conditions. For instance, if the sunlight is strong in the daytime, the daytime strong light-preventing soft screen 4 can be pulled out and unwound for blocking off strong sunlight. At this time, the elastic member 21 will be rotated to make resilience contraction because one end of the elastic member 21 is engaged with the first winding tube 20 and another end has the engage member 210 engaged and secured together with the insert recess 220 of the braking rod that has the positioning projection 221 at one end immovably fixed in place by the engage slot 130 of the outer frame 1. And, with the help of the gravitational member 40 at the outer end of the daytime strong light-preventing soft screen 4, the daytime strong light-preventing soft screen 4 can be stabilized not to flutter about. To wind the daytime strong light-preventing soft screen 4, only pull the actuating member 642 of the actuating rod 64 to have the resisting surface 641 pushing out the braking ratchet wheel 62 due to leverage, letting the braking engage surface 620 of the braking ratchet wheel 62 disengaged from the braking engage surface 630 of the engage ratchet wheel 63. Simultaneously, by function of contraction resilience of the elastic member 21 in the first winding tube 20, the daytime strong light-preventing soft screen 4 will be wound in the interior of the first winding tube 20. When driving at night, simply pull down the nighttime strong light-preventing soft screen 5 for filtering strong light of automobile lamps in opposite direction without affecting a driver's eyesight, enabling the driver to drive with concentration for insuring driving safety.

As can be understood from the above description, this invention has the following advantages.

1. The strong light-preventing soft screen for the front seat of an automobile in the present invention can be optionally employed in the daytime or in the nighttime for obstructing strong light so it is unnecessary for a driver to wear sunglasses.

2. The strong light-preventing soft screen for the front seat of an automobile of this invention can easily be secured on the windshield of an automobile, extremely convenient in assembly.

3. The daytime and nighttime strong light-preventing soft screen of this invention respectively have a lower end additionally fixed with a gravitational member so that, after being pulled down and expanded, the daytime and the nighttime strong light-preventing soft screen can be stabilized not to flutter about.

While the preferred embodiment of the invention has been described above, it will be recognized and understood that various modifications may be made therein and the appended claims are intended to cover all such modifications that may fall within the spirit and scope of the invention.

What is claim is:

1. A daytime and nighttime light filtering device for the front seat of an automobile comprising:
an outer frame formed with two circular arc surfaces, said outer frame having one side provided with an insert groove and a positioning threaded hole and another side mounted with a combining seat and a cap, said combining seat formed with engage slots and positioning slots, said cap provided with insert projections to be respectively engaged with said engage slots of said combining seat, said outer frame having back side disposed with positioning grooves and sucking disks;
two winding mechanisms respectively fitted in said circular arc surfaces of said outer frame, each said winding mechanism composed of a winding tube, an elastic member and a braking rod, said winding tube having one side provided with a fitting member and another side disposed with an insert member, said winding tube cut with a notch, said elastic member received in the interior of said winding tube, said elastic member having an engage member and an insert groove, said braking rod inserted in said elastic member, and having one end bored with an insert recess and another end formed with a positioning projection;
a daytime strong light-preventing soft screen wound around said first winding tube, said daytime strong light-preventing soft screen having one end engaged and firmly positioned in said notch of said first winding tube, said daytime strong light-preventing soft screen wound around the surface of said first winding tube, said daytime strong light-preventing soft screen having an outer end fixed with a gravitational member and a pull member;
a nighttime strong light-preventing soft screen wound around said second winding tube, said nighttime strong light-preventing soft screen having one end engaged and secured in said notch of said second winding tube, said nighttime strong light-preventing soft screen wound around the surface of said second winding tube, said nighttime strong light-preventing soft screen having an outer end fixed with a gravitational member and a pull member; and
a positioning mechanism fitted on said insert groove of said outer frame, said positioning mechanism composed of a fitting base, elastic members, braking ratchet wheels, engage ratchet wheels and actuating rods, said fitting base bored with two fitting round holes, two insert holes and a positioning threaded hole, said elastic members respectively received in said two fitting round holes, said braking ratchet wheels respectively fitted in said round holes of said fitting base and extended out of said insert holes, each said braking ratchet wheel having one end provided with a braking engage surface and another end extended out to form a connecting rod with an insert hole at end, said engage ratchet wheels respectively set in said fitting member of said two winding tubes, each said engage ratchet wheel having one end formed with a braking engage surface and another end provided with an engage portion, said actuating rods respectively positioned in front of said insert holes of said fitting base, each said actuating rod disposed with positioning holes, a resisting surface and an actuating member.

2. A daytime and nighttime light filtering device for the front seat of an automobile as claimed in claim 1, wherein said daytime strong light-preventing soft screen is preferably made of dark brown-colored filtering material.

3. A daytime and nighttime light filtering device for the front seat of an automobile as claimed in claim 1, wherein said nighttime strong light-preventing soft screen is made of yellow-colored filtering material.
